(19) United States
(12) Patent Application Publication
(10) Pub. No.: US 2025/0110858 A1
(43) Pub. Date: Apr. 3, 2025

(54) CODE COVERAGE RATE DETERMINING METHOD AND APPARATUS

(71) Applicant: Beijing Volcano Engine Technology Co., Ltd., Beijing (CN)

(72) Inventors: Liang Zhu, Beijing (CN); Lei Gu, Beijing (CN); Feifei Lv, Beijing (CN); Paifeng Cheng, Beijing (CN); Leiting Hu, Beijing (CN)

(21) Appl. No.: 18/829,580

(22) Filed: Sep. 10, 2024

(30) Foreign Application Priority Data
Sep. 28, 2023 (CN) 202311278001.8

(51) Int. Cl. G06F 11/36

(52) U.S. Cl. CPC G06F 11/3676

(57) ABSTRACT

A code coverage rate determining method, comprising: obtaining coverage rate test data to be processed and determining a code branch corresponding to the coverage rate test data to be processed, the coverage rate test data to be processed indicating a coverage rate of a software code corresponding to a first code change record identifier; obtaining historical coverage rate test data corresponding to the code branch, the historical coverage rate test data indicating a coverage rate of a software code corresponding to a second code change record identifier; in case that the first code change record identifier or the second code change record identifier includes a latest code change record identifier corresponding to the code branch, merging first coverage rate test data into second first coverage rate test data in accordance with the position of the first software code in the second software code, to obtain target coverage rate test data.

### CROSS-REFERENCE TO RELATED APPLICATION(S)

This application claims priority to Chinese Application No. 202311278001.8 filed on Sep. 28, 2023, the disclosures of which are incorporated herein by reference in their entirety.

### FIELD

The present disclosure relates to the field of computer technologies, and more specifically, to a code coverage rate determining method and apparatus.

### BACKGROUND

Code coverage rate may reflect executions of software codes. Specifically, the code coverage rate may indicate which codes of the software codes are executed and which ones are not. For one thing, the code coverage rate may show the quality of software codes. For another, in test scenarios, a determination may also be made as to whether the test target has been achieved based on the code coverage rate.

At present, software codes of a certain operation system are generally developed and tested collaboratively, to improve code delivery efficiency. Different personnel may perform the coverage rate test on the software codes they are responsible for, to gain corresponding coverage rate test data.

However, it is yet an issue to be solved as to how the overall coverage rate test data of the software codes corresponding to the operation system are obtained on the basis of the coverage rate test data acquired from different personnel.

### SUMMARY

To solve or at least partly solve the above technical problem, embodiments of the present disclosure provide a code coverage rate determining method and apparatus.

In a first aspect, embodiments of the present disclosure provide a code coverage rate determining method, the method comprising:
obtaining coverage rate test data to be processed and determining a code branch corresponding to the coverage rate test data to be processed, the coverage rate test data to be processed indicating a coverage rate of a software code corresponding to a first code change record identifier;
obtaining historical coverage rate test data corresponding to the code branch, the historical coverage rate test data indicating a coverage rate of a software code corresponding to a second code change record identifier;
in case that the first code change record identifier or the second code change record identifier includes a latest code change record identifier corresponding to the code branch, determining a position of a first software code in a second software code and merging first coverage rate test data into second first coverage rate test data in accordance with the position of the first software code in the second software code, to obtain target coverage rate test data; wherein:

the first coverage rate test data is the coverage rate test data to be processed or the historical coverage rate test data; a code change record identifier corresponding to the first coverage rate test data does not include the latest code change record identifier; the second coverage rate test data is the coverage rate test data to be processed or the historical coverage rate test data; a code change record identifier corresponding to the second coverage rate test data includes the latest code change record identifier; the first software code is a software code corresponding to the first coverage rate test data, and the second software code is a software code corresponding to the second coverage rate test data.

Optionally, determining a position of a first software code in a second software code includes:
determining a position of a target code in the first software code in the second software code, the target code being an executed code indicated by the first coverage rate test data.

Optionally, a software code corresponding to the first code change record identifier corresponds to a first software version, a software code corresponding to the second code change record identifier corresponds to a second software version, the first software version being different from the second software version.

Optionally, the coverage rate test data to be processed include any one of:
full coverage rate test data, coverage rate test data produced during test, coverage rate test data corresponding to a test plan or coverage rate test data corresponding to a test use case.

Optionally, the method also comprises:
determining the latest code change record identifier;
judging whether the first code change record identifier and the code change record identifier include the latest code change record identifier.

Optionally, the method also comprises:
in case that neither the first code change record identifier nor the code change record identifier includes the latest code change record identifier and the first code change record is different from the second code change record, discarding the coverage rate test data to be processed.

Optionally, the method also comprises:
in case that neither the first code change record identifier nor the code change record identifier includes the latest code change record identifier and the first code change record is the same as the second code change record, merging the coverage rate test data to be processed and the historical coverage rate test data.

In a second aspect, embodiments of the present disclosure provide a code coverage rate determining apparatus, the apparatus comprising:
a first obtaining unit for obtaining coverage rate test data to be processed and determining a code branch corresponding to the coverage rate test data to be processed, the coverage rate test data to be processed indicating a coverage rate of a software code corresponding to a first code change record identifier;
a second obtaining unit for obtaining historical coverage rate test data corresponding to the code branch, the historical coverage rate test data indicating a coverage rate of a software code corresponding to a second code change record identifier;
a first determining unit for, in case that the first code change record identifier or the second code change record identifier includes a latest code change record identifier corresponding to the code branch, determining a position of a first software code in a second software code;
a first merging unit for merging first coverage rate test data into second first coverage rate test data in accordance with the position of the first software code in the second software code, to obtain target coverage rate test data; wherein:
the first coverage rate test data is the coverage rate test data to be processed or the historical coverage rate test data; a code change record identifier corresponding to the first coverage rate test data does not include the latest code change record identifier; the second coverage rate test data is the coverage rate test data to be processed or the historical coverage rate test data; a code change record identifier corresponding to the second coverage rate test data includes the latest code change record identifier; the first software code is a software code corresponding to the first coverage rate test data, and the second software code is a software code corresponding to the second coverage rate test data.

Optionally, the first determining unit is provided for:
determining a position of a target code in the first software code in the second software code, the target code being an executed code indicated by the first coverage rate test data.

Optionally, a software code corresponding to the first code change record identifier corresponds to a first software version, a software code corresponding to the second code change record identifier corresponds to a second software version, the first software version being different from the second software version.

Optionally, the coverage rate test data to be processed include any one of:
full coverage rate test data, coverage rate test data produced during test, coverage rate test data corresponding to a test plan or coverage rate test data corresponding to a test use case.

Optionally, the apparatus also comprises:
a second determining unit for determining the latest code change record identifier;
a judging unit for judging whether the first code change record identifier and the code change record identifier include the latest code change record identifier.

Optionally, the apparatus also comprises:
a discarding unit for, in case that neither the first code change record identifier nor the code change record identifier includes the latest code change record identifier and the first code change record is different from the second code change record, discarding the coverage rate test data to be processed.

Optionally, the apparatus also comprises:
a second merging unit for, in case that neither the first code change record identifier nor the code change record identifier includes the latest code change record identifier and the first code change record is the same as the second code change record, merging the coverage rate test data to be processed and the historical coverage rate test data.

In a third aspect, embodiments of the present disclosure provide an electronic device, comprising: a processor and a memory;
the processor is provided for executing instructions stored in the memory to cause the device to perform the method according to the above first aspect.

In a fourth aspect, embodiments of the present disclosure provide a computer-readable storage medium, comprising instructions that instruct a device to execute the method according to the above first aspect.

In a fifth aspect, embodiments of the present disclosure provide a computer program product, which computer program product, when running on a computer, enables the computer to execute the method according to the above first aspect.

Compared to the prior art, the embodiments of the present disclosure have following advantages:

Embodiments of the present disclosure provide a code coverage rate determining method and the method for example may be applied to a test platform. The method comprises: obtaining coverage rate test data to be processed, the coverage rate test data to be processed indicating a coverage rate of a software code corresponding to a first code change record identifier. After the coverage rate test data to be processed are obtained, a code branch corresponding to the coverage rate test data to be processed may be determined. Further, historical coverage rate test data corresponding to the code branch are obtained, and the historical coverage rate test data may be the coverage rate test data of a corresponding code branch stored by the test platform. Furthermore, in case that the first code change record identifier or the second code change record identifier includes a latest code change record identifier corresponding to the code branch, the first coverage rate test data is merged into the second first coverage rate test data, to obtain target coverage rate test data; wherein a first code change record identifier includes the latest code change record identifier indicating the coverage rate test data to be processed as the coverage rate test data of the latest code of the code branch; if the second code change record identifier includes the latest code change record identifier, it indicates that the historical coverage rate test data is the coverage rate test data of the latest code of the code branch. In such case, the first coverage rate test data indicating having a corresponding code change record identifier excluding the latest code change record identifier in the coverage rate test data to be processed and the historical coverage rate test data is merged into the second coverage rate test data having a corresponding code change record identifier including the latest code change record identifier in the coverage rate test data to be processed and the historical coverage rate test data, so as to obtain the coverage rate test data matching the latest code of the code branch. Specifically, considering that the first software code differs from the second software code, the position of the first software code in the second software code may be determined, to fulfill merging of the coverage rate test data. Besides, the first coverage rate test data is merged into the second coverage rate test data in accordance with the position of the first software code in the second software code, to obtain the target coverage rate test data, wherein the first software code is the software code corresponding to the first coverage rate test data, and the second software code is the software code corresponding to the second coverage rate test data. Hence, with the solution according to the embodiments of the present disclosure, the coverage rate test data to be processed (e.g., the coverage rate test data obtained from a researcher) may be merged with the historical coverage rate test data to obtain the target coverage rate test data matching the latest code of the code branch.

### BRIEF DESCRIPTION OF THE DRAWINGS

Brief introduction of the drawings required in the description of the specific embodiments or the prior art are to be provided below to more clearly explain the technical solutions according to the embodiments of the present disclosure or in the prior art. It is obvious that the following drawings illustrate some embodiments of the present disclosure and those skilled in the art also may obtain other drawings on the basis those illustrated ones without any exercises of inventive work.

FIG. 1 illustrates a schematic flowchart of a code coverage rate determining method provided by embodiments of the present disclosure;

FIG. 2 illustrates a schematic diagram of a code coverage rate determining method provided by embodiments of the present disclosure;

FIG. 3 illustrates a schematic flow of a queue scheduling method provided by embodiments of the present disclosure;

FIG. 4 illustrates a structural diagram of a code coverage rate determining apparatus provided by embodiments of the present disclosure.

### DETAILED DESCRIPTION OF EMBODIMENTS

To allow those skilled in the art to better understand the technical solution of the present disclosure, the technical solution in the embodiments of the present disclosure are to be described clearly and comprehensively below with reference to the drawings in the embodiments of the present disclosure. Apparently, the described embodiments are only part of the embodiments of the present disclosure, rather than all of them. Based on the embodiments of the present disclosure, all other embodiments obtained by those skilled in the art without requiring any exercises of inventive work should fall within the protection scope of the present disclosure.

### Example Method

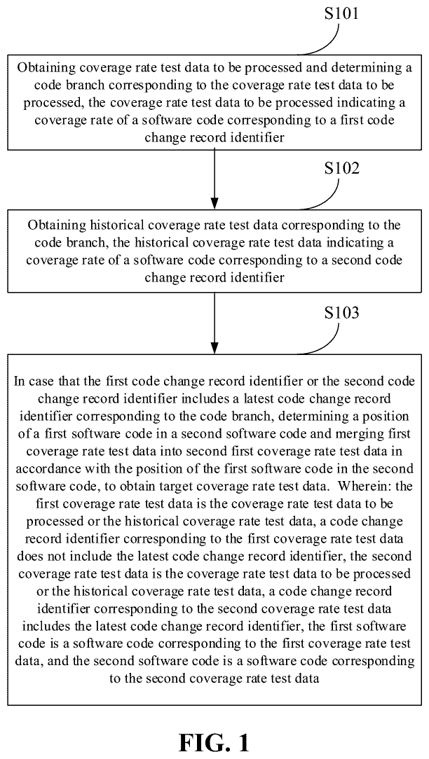

FIG. 1 illustrates a schematic flow of a code coverage rate determining method according to embodiments of the present disclosure.

The code coverage rate determining method provided by embodiments of the present disclosure may be applied to a test platform. The method shown in FIG. 1 for example may include following steps S101-S103.

S101: obtaining coverage rate test data to be processed and determining a code branch corresponding to the coverage rate test data to be processed, the coverage rate test data to be processed indicating a coverage rate of a software code corresponding to a first code change record identifier.

In the embodiments of the present disclosure, a coverage rate test result to be processed may be obtained, where the coverage rate test result to be processed includes the coverage rate test data to be processed consisting of a software code corresponding to a first code change record identifier and executions of respective lines of software codes. In one example, the coverage rate test result to be processed also may indicate the first code change record identifier. Accordingly, the first code change record identifier corresponding to the coverage rate test data to be processed may be determined via the coverage rate test result to be processed. In the embodiments of the present disclosure, the coverage rate test result may be a coverage rate test report.

The first code change record identifier may include at least one code change record identifier, wherein the code change record identifier may identify a code change record. Every time the researcher commits the code, this commitment will correspond to one code change record identifier, which is also known as commit identifier (commit ID). For example, the first code change record identifier may include 10 code change record identifiers, respectively being 1 to 10.

In another example, the coverage rate test result to be processed also may indicate a code branch corresponding to the coverage rate test data to be processed. Therefore, the code branch corresponding to the coverage rate test data to be processed may be determined based on the coverage rate test result to be processed, wherein the code branch may also be referred to as branch code for identifying a given branch in the entire software code.

The coverage rate test result to be processed is not specifically defined by the embodiments of the present disclosure, and may be a file in a particular format, such as file in json format.

In the embodiments of the present disclosure, the coverage rate test data to be processed may be the coverage rate test data corresponding to a certain researcher.

In one example, the coverage rate test data to be processed may be full coverage rate test data, i.e., the coverage rate test data obtained after completing construction of software codes corresponding to the entire operation system.

In a further example, the coverage rate test data to be processed may be coverage rate test data produced during the test, wherein the coverage rate test data may be reported to the test platform periodically during the test; the coverage rate test data to be processed may be single coverage rate test data reported, and the single coverage rate test data may be understood as the coverage rate test data produced and reported at a certain reporting time. In some embodiments, to avoid consuming excessive resources due to frequent reporting of single coverage rate data, multiple single coverage rate test data for the same commit ID may be merged before being reported. In other words, the coverage rate test data to be processed may be the coverage rate test data resulted from merging multiple single coverage rate test data.

In one example, the coverage rate test data to be processed may be the coverage rate test data corresponding to the test plan, and the test plan may include a plurality of test use cases, where each test use case may test one or more functions. In another example, the coverage rate test data to be processed also may be the coverage rate test data corresponding to the test use case.

S102: obtaining historical coverage rate test data corresponding to the code branch, the historical coverage rate test data indicating a coverage rate of a software code corresponding to a second code change record identifier.

In one example, after the code branch corresponding to the coverage rate test data to be processed is determined, the test platform is queried to see if it stores the historical coverage rate test data corresponding to the code branch. If the test platform does not store the historical coverage rate test data corresponding to the code branch, the coverage rate test data to be processed is identified as a first copy of coverage rate test data corresponding to the code branch. In such case, the coverage rate test data to be processed may be directly saved. If the test platform is stored with the historical coverage rate test data corresponding to the code branch, the historical coverage rate test data may be obtained.

In one example, in a specific implementation of obtaining the historical coverage rate test data, a historical coverage rate test result may be obtained. The historical coverage rate test result includes the historical coverage rate test data consisting of a software code corresponding to a second code change record identifier and executions of respective lines of software codes. In one example, the historical coverage rate test result also may indicate the second code change record identifier. Therefore, the second code change record identifier corresponding to the historical coverage rate test data may be determined through the historical coverage rate test result.

Similar to the first code change record identifier, the second code change record identifier may include at least one code change record identifier. For example, the second code change record identifier may include 20 code change record identifiers, respectively being 1 to 20. For another example, the second code change record identifier may include 5 code change record identifiers, respectively being 1 to 5.

S103: in case that the first code change record identifier or the second code change record identifier includes a latest code change record identifier corresponding to the code branch, determining a position of a first software code in a second software code and merging first coverage rate test data into second first coverage test data in accordance with the position of the first software code in the second software code, to obtain target coverage rate test data; wherein: the first coverage rate test data is the coverage rate test data to be processed or the historical coverage rate test data; a code change record identifier corresponding to the first coverage rate test data does not include the latest code change record identifier; the second coverage rate test data is the coverage rate test data to be processed or the historical coverage rate test data; a code change record identifier corresponding to the second coverage rate test data includes the latest code change record identifier; the first software code is a software code corresponding to the first coverage rate test data, and the second software code is a software code corresponding to the second coverage rate test data.

In one example, after the coverage rate test data to be processed and the historical coverage rate test data are obtained, a determination may be further made as to whether the coverage rate test data to be processed and the historical coverage rate test data contain the coverage rate test data for the latest code of the code branch. Specifically, the test platform may record every code change record identifier corresponding to the code branch. Accordingly, the latest code change record identifier corresponding to the code branch may be obtained. Moreover, the first code change record identifier is compared with the latest code change record identifier to determine whether the coverage rate test data to be processed is the coverage rate test data for the latest code of the code branch. In addition, the second code change record identifier is compared with the latest code change record identifier to determine whether the historical coverage rate test data is the coverage rate test data for the latest code of the code branch. To be specific, if the first code change record identifier includes the latest code change record identifier, it means that the coverage rate test data to be processed is the coverage rate test data for the latest code of the code branch. If not, it indicates that the coverage rate test data to be processed is not the coverage rate test data for the latest code of the code branch.

Likewise, if the second code change record identifier includes the latest code change record identifier, it means that the historical coverage rate test data is the coverage rate test data for the latest code of the code branch. If not, it indicates that the historical coverage rate test data is not the coverage rate test data for the latest code of the code branch.

If the first code change record identifier or the second code change record identifier includes the latest code change record identifier corresponding to the code branch, it indicates that one of the coverage rate test data to be processed and the historical coverage rate test data is the coverage rate test data for the latest code of the code branch. In the embodiments of the present disclosure, the coverage rate test data for the latest code of the code branch in the coverage rate test data to be processed and the historical coverage rate test data are known as first coverage rate test data; and the coverage rate test data not directed to the latest code of the code branch in the coverage rate test data to be processed and the historical coverage rate test data are referred to as second coverage rate test data. Hence, the first coverage rate test data is the coverage rate test data to be processed or the historical coverage rate test data; a code change record identifier corresponding to the first coverage rate test data does not include the latest code change record identifier; the second coverage rate test data is the coverage rate test data to be processed or the historical coverage rate test data; a code change record identifier corresponding to the second coverage rate test data includes the latest code change record identifier.

In the embodiments of the present disclosure, the first coverage rate test data may be merged into second first coverage test data to obtain target coverage rate test data matching the latest code of the code branch. Specifically, considering that the first software code corresponding to the first coverage rate test data differs from a software code corresponding to the second coverage rate test data, the position of the first software code in the second software code may be determined, to fulfill merging of the coverage rate test data. To be specific, in one example, a variance calculation may be performed on the first software code and the second software code, to obtain a variance portion between the first software code and the second software code. The position of the first software code in the second software code is further determined based on the variance portion. In a further example, the first software code is compared with the second software code line by line, to further obtain the position of the first software code in the second software code.

In one example, the position of each line of software code of the first software code in the second software code may be determined. In another example, since the merging of the coverage rate test data mainly involves merging the executions of the executed codes, the position of the target code in the first software code in the second software code is determined, wherein the target code is an executed code indicated by the first coverage rate test data.

Wherein the first software code corresponding to the first coverage rate test data denotes that the first coverage rate test data include executions of the first software code; and the second software code corresponding to the second coverage rate test data indicates that the second coverage rate test data include executions of the second software code.

After the position of the first software code in the second software code is determined, the first coverage rate test data may be merged into the second coverage rate test data in accordance with the position, to obtain the target coverage rate test data. Specifically, if the target code in the first software code corresponds to the tenth line in the second software code, indication information indicating the code in the tenth line being covered may be written into the second coverage rate test data. Examples are now provided to explain the first coverage rate test data, the second coverage rate test data and the target coverage rate test data:

Assuming that the first coverage rate test data indicate that the fifth to seventh lines of the first software code are covered and a sixth line is inserted into the second software code on the basis of the first software code, the positions of the fifth to the seventh lines of the first software code in the second software code are demonstrated in the Table 1 below:

TABLE 1

| First Software Code | Second Software Code |
|---|---|
| Fifth line | Fifth Line |
| Sixth Line | Seventh Line |
| Seventh Line | Eighth Line |

Correspondingly, the generated target coverage rate test data indicate that the fifth line, the seventh line and the eighth line are covered.

In other words, with the solution according to the embodiments of the present disclosure, the first coverage rate test data may be combined into the second coverage rate test data matching the latest code of the code branch, so as to obtain the target coverage rate test data matching the latest code of the code branch. In one example, after the target coverage rate is obtained, the test platform may replace the historical coverage rate test data with the target coverage rate test data.

Through the above description, by the solution according to the embodiments of the present disclosure, the coverage rate test data to be processed (e.g., the coverage rate test data obtained by a researcher) and the historical coverage rate test data may be merged to obtain the target coverage rate test data matching the latest code of the code branch.

In one example, a software code corresponding to the first code change record identifier corresponds to a first software version, a software code corresponding to the second code change record identifier corresponds to a second software version, the first software version being different from the second software version. In such case, by the solution according to the embodiments of the present disclosure, the coverage rate test data corresponding to different versions of the software codes of the branch code may be merged. It is certain that the first software version and the second software version may also be the same. Embodiments of the present disclosure are not specifically restricted in this regard.

As stated above, after the coverage rate test data to be processed and the historical coverage rate test data are obtained, a determination may be further made as to whether the coverage rate test data to be processed and the historical coverage rate test data contain the coverage rate test data for the latest code of the code branch. In one example, if the coverage rate test data to be processed and the historical coverage rate test data do not contain the coverage rate test data for the latest code of the code branch, it means that the first code change record identifier and the code change record identifier do not include the latest code change record identifier. For such case:

In one example, in case that the first code change record is identical to the second code change record, the coverage rate test data to be processed and the historical coverage rate test data are identified to be directed at the same software code. Accordingly, the coverage rate test data is to be processed and the historical coverage rate test data may be merged. For example, the coverage rate test data to be processed is added into the historical coverage rate test data. Correspondingly, the test platform may save the historical coverage rate test data added with the coverage rate test data to be processed, such that the test platform saves more complete coverage rate information for the software code corresponding to the historical coverage rate test data.

In another example, if the first code change record and the second code change record are different, both the coverage rate test data to be processed and the historical coverage rate test data are identified to be directed at non-latest software code. In such case, it makes no sense to merge the historical coverage rate test data and the coverage rate test data to be processed, and the coverage rate test data to be processed may be discarded.

In one example, after the target coverage rate test data is determined, display of the target coverage rate test data may also be supported. For example, the target coverage rate test data (e.g., total lines of codes and executed code lines) are displayed on a relevant interface. Besides, it is also enabled to query the covered data with particular fields, e.g., querying the full coverage rate test data and the coverage rate test data corresponding to the test plan etc.

The code coverage rate determining method provided by embodiments of the present disclosure has been introduced above. Next, the code coverage rate determining method provided by embodiments of the present disclosure is to be explained with reference to specific examples.

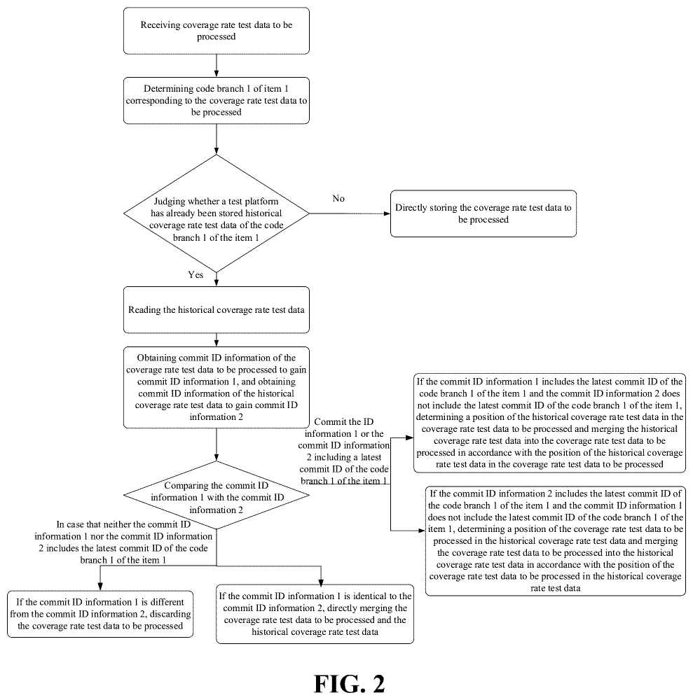

FIG. 2 illustrates a schematic flow of a code coverage rate determining method provided by embodiments of the present disclosure. As shown in FIG. 2:

The test platform may receive the coverage rate test data to be processed and further determine a code branch 1 of an item 1 corresponding to the coverage rate test data to be processed. Further, it is determined whether the test platform has already stored with the historical coverage rate test data of the code branch 1 of the item 1. If the test platform is not stored with the historical coverage rate test data of the code branch 1 of the item 1, the coverage rate test data to be processed is directly stored.

If the test platform is not stored with the historical coverage rate test data of the code branch 1 of the item 1, the historical coverage rate test data is read.

Moreover, commit ID information of the coverage rate test data to be processed is obtained to gain commit ID information 1; and commit information of the historical coverage rate test data is obtained to gain commit ID information 2; and the commit ID information 1 is compared with the commit ID information 2.

In case that the commit ID information 1 or the commit ID information 2 includes the latest commit ID of the code branch 1 of the item 1:

If the commit ID information 1 includes the latest commit ID of the code branch 1 of the item 1 and the commit ID information 2 does not include the latest commit ID of the code branch 1 of the item 1, the position of the historical coverage rate test data in the coverage rate test data to be processed is determined and the historical coverage rate test data are merged into the coverage rate test data to be processed in accordance with the position of the historical coverage rate test data in the coverage rate test data to be processed.

If the commit ID information 2 includes the latest commit ID of the code branch 1 of the item 1 and the commit ID information 1 does not include the latest commit ID of the code branch 1 of the item 1, the position of the coverage rate test data to be processed in the historical coverage rate test data is determined and the coverage rate test data to be processed are merged into the historical coverage rate test data in accordance with the position of the coverage rate test data to be processed in the historical coverage rate test data.

In case that neither the commit ID information 1 nor the commit ID information 2 includes the latest commit ID of the code branch 1 of the item 1:

If the commit ID information 1 is different from the commit ID information 2, the coverage rate test data to be processed are discarded; if the commit ID information 1 is the same as the commit ID information 2, the coverage rate test data to be processed and the historical coverage rate test data are directly merged.

Massive coverage rate test data to be processed exist in practical applications and the test platform has too restricted capability to handle the massive coverage rate test data to be processed simultaneously. Given the circumstance, in the embodiments of the present disclosure, the coverage rate test data to be processed may be stored into queues and then the coverage rate test data to be processed are read from the queues according to a given policy and processed. In other words, the coverage rate test data to be processed in S101 may be the coverage rate test data read from the queues.

In a scenario where large amounts of coverage rate test data are to be processed, a task may be triggered at a stated time during a period of time when fewer resources are used, to add the data to the queue.

In addition, as to the aforementioned single coverage rate test data, the differences among the consecutively reported single coverage rate test data are small. As such, multiple single coverage rate test data for the same commit ID may be merged before being added to the queues.

Moreover, different priorities may be set for various types of coverage rate test data, and the coverage rate test data is placed into a queue of a corresponding priority. For example, due to the low real-time requirement for the full coverage rate test data, the coverage rate test data corresponding to the test plan and the coverage rate test data corresponding to the test use case, they may be provided with a low priority, whereas the coverage rate test data produced in the course of test may be assigned with a high priority.

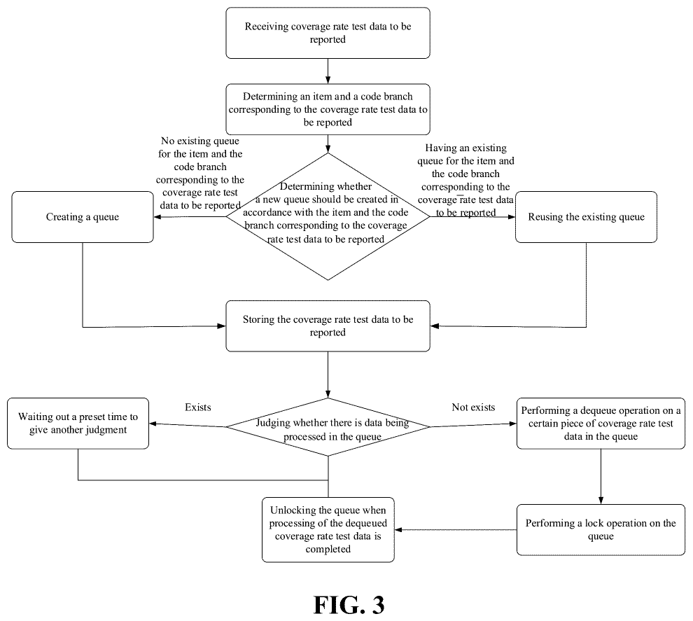

Next, a scheduling process related to the queues is to be introduced. FIG. 3 illustrates a schematic flow of a queue scheduling method provided by the embodiments of the present disclosure.

As shown in FIG. 3, coverage rate test data to be reported is received first. Then, an item and a code branch corresponding to the coverage rate test data to be reported are determined and it is determined whether a new queue should be created in accordance with the item and code branch corresponding to the coverage rate test data to be reported. Specifically, if there is an existing queue for the item and code branch corresponding to the coverage rate test data to be reported, the existing queue is directly reused to store the coverage rate test data to be reported. If not, a queue is created to store the coverage rate test data to be reported.

Furthermore, it is determined on regular basis whether there is data being processed (wherein if the queue is locked, it indicates there are data being processed; if not, it means that no data are being processed). If there is data being processed, a preset time is waited out to give another judgment. If there is no data being processed, a dequeue operation is performed on a certain piece of coverage rate test data in the queue, and a locking operation is executed on the queue to avoid causing exceptions in handling the coverage rate test data if a new piece of coverage rate test data is dequeued while the processing on the previously dequeued coverage rate test data is not completed. When the processing on the aforementioned dequeued coverage rate test data is completed, the queue is unlocked.

Additionally, a time-out task may also be configured. For example, when a locked queue is not unlocked after a certain period of time has elapsed, the queue is unlocked automatically, to prevent exceptions in handling a certain piece of coverage rate test data from affecting the subsequent processing on other coverage rate test data in the queue.

### Example Device

In view of the above method provided by the embodiments, the embodiments of the present disclosure also provide an apparatus, which is to be introduced below with reference to the drawings.

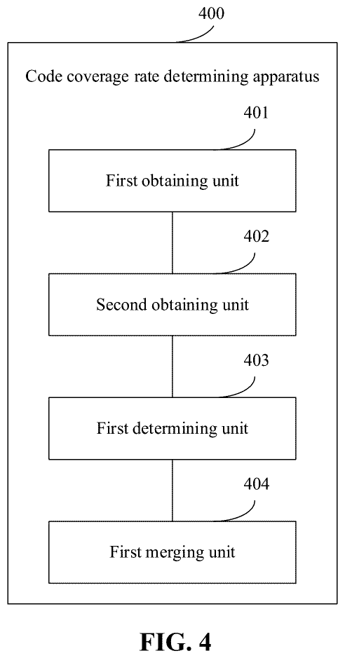

FIG. 4 illustrates a structural diagram of a code coverage rate determining apparatus provided by embodiments of the present disclosure. The code coverage rate determining apparatus 400 as shown in FIG. 4 may include: a first obtaining unit 401, a second obtaining unit 402, a first determining unit 403 and a first merging unit 404.

A first obtaining unit 401 is provided for obtaining coverage rate test data to be processed and determining a code branch corresponding to the coverage rate test data to be processed, the coverage rate test data to be processed indicating a coverage rate of a software code corresponding to a first code change record identifier;

A second obtaining unit 402 is used for obtaining historical coverage rate test data corresponding to the code branch, the historical coverage rate test data indicating a coverage rate of a software code corresponding to a second code change record identifier;

A first merging unit 403 is provided for, in case that the first code change record identifier or the second code change record identifier includes a latest code change record identifier corresponding to the code branch, determining a position of a first software code in a second software code;

A first merging unit 404 is used for merging first coverage rate test data into second first coverage rate test data in accordance with the position of the first software code in the second software code, to obtain target coverage rate test data; wherein:
the first coverage rate test data is the coverage rate test data to be processed or the historical coverage rate test data; a code change record identifier corresponding to the first coverage rate test data does not include the latest code change record identifier; the second coverage rate test data is the coverage rate test data to be processed or the historical coverage rate test data; a code change record identifier corresponding to the second coverage rate test data includes the latest code change record identifier; the first software code is a software code corresponding to the first coverage rate test data, and the second software code is a software code corresponding to the second coverage rate test data.

Optionally, the first determining unit 403 is provided for:
determining a position of a target code in the first software code in the second software code, the target code being an executed code indicated by the first coverage rate test data.

Optionally, a software code corresponding to the first code change record identifier corresponds to a first software version, a software code corresponding to the second code change record identifier corresponds to a second software version, the first software version being different from the second software version.

Optionally, the coverage rate test data to be processed include any one of:
full coverage rate test data, coverage rate test data produced during test, coverage rate test data corresponding to a test plan or coverage rate test data corresponding to a test use case.

Optionally, the apparatus also comprises:
a second determining unit for determining the latest code change record identifier;
a judging unit for judging whether the first code change record identifier and the code change record identifier include the latest code change record identifier.

Optionally, the apparatus also comprises:
a discarding unit for, in case that neither the first code change record identifier nor the code change record identifier includes the latest code change record identifier and the first code change record is different from the second code change record, discarding the coverage rate test data to be processed.

Optionally, the apparatus also comprises:
a second merging unit for, in case that neither the first code change record identifier nor the code change record identifier includes the latest code change record identifier and the first code change record is the same as the second code change record, merging the coverage rate test data to be processed and the historical coverage rate test data.

Since the apparatus 400 corresponds to the code coverage rate determining method provided by the above method embodiments, specific implementations of respective units of the apparatus 400 follow the same inventive concept as the above method embodiments. Thus, the specific implementations of respective units of the apparatus 400 may refer to the related description about the above method embodiments and will not be covered here.

Embodiments of the present disclosure also provide an electronic device. The device comprises a processor and a memory;
the processor is provided for executing instructions stored in the memory to cause the device to perform the code coverage rate determining method provided by the above method embodiments.

Embodiments of the present disclosure also provide a computer-readable storage medium, comprising instructions that instruct a device to execute the code coverage rate determining method provided by the above method embodiments.

Embodiments of the present disclosure also provide a computer program product, which computer program product, when running on a computer, enable the computer to execute the code coverage rate determining method provided by the above method embodiments.

Those skilled in the art can easily think of other implementations of the present disclosure after reviewing the description and putting the disclosed invention into practice. The present disclosure is intended to cover any variations, uses, or adaptive changes of the present disclosure. These variations, uses, or adaptive changes follow the general principles of the present disclosure and include the common knowledge or the customary technical means in the art, which are not disclosed in the present disclosure. The description and the embodiments are provided merely for exemplary purpose, and the scope and spirit of the present disclosure are indicated by the claims.

It is to be understood that the present disclosure is not limited to the accurate structures described above and illustrated in the drawings, and various modifications and changes are feasible without deviating from the scope. The scope of the present disclosure is subject to the attached claims.

The above embodiments are preferred embodiments of the present disclosure and shall not restrict the present disclosure. Any modifications, equivalent substitutions and improvements shall fall within the protection scope of the present disclosure as long as they are within the spirit and principle of the present disclosure.

I/We claim:

1. A code coverage rate determining method, comprising:
obtaining coverage rate test data to be processed and determining a code branch corresponding to the coverage rate test data to be processed, the coverage rate test data to be processed indicating a coverage rate of a software code corresponding to a first code change record identifier;
obtaining historical coverage rate test data corresponding to the code branch, the historical coverage rate test data indicating a coverage rate of a software code corresponding to a second code change record identifier; and
in case that the first code change record identifier or the second code change record identifier includes a latest code change record identifier corresponding to the code branch, determining a position of a first software code in a second software code and merging first coverage rate test data into second first coverage rate test data in accordance with the position of the first software code in the second software code, to obtain target coverage rate test data; wherein:
the first coverage rate test data is the coverage rate test data to be processed or the historical coverage rate test data, a code change record identifier corresponding to the first coverage rate test data does not include the latest code change record identifier, the second coverage rate test data is the coverage rate test data to be processed or the historical coverage rate test data, a code change record identifier corresponding to the second coverage rate test data includes the latest code change record identifier, the first software code is a software code corresponding to the first coverage rate test data, and the second software code is a software code corresponding to the second coverage rate test data.

2. The method of claim 1, wherein determining a position of a first software code in a second software code includes:
determining a position of a target code in the first software code in the second software code, the target code being an executed code indicated by the first coverage rate test data.

3. The method of claim 1, wherein a software code corresponding to the first code change record identifier corresponds to a first software version, a software code corresponding to the second code change record identifier corresponds to a second software version, and the first software version is different from the second software version.

4. The method of claim 1, wherein the coverage rate test data to be processed include any one of:
full coverage rate test data, coverage rate test data produced during test, coverage rate test data corresponding to a test plan or coverage rate test data corresponding to a test use case.

5. The method of claim 1, further comprising:
determining the latest code change record identifier; and
judging whether the first code change record identifier and the code change record identifier include the latest code change record identifier.

6. The method of claim 5, further comprising:
In case that neither the first code change record identifier nor the code change record identifier includes the latest code change record identifier and the first code change record is different from the second code change record, discarding the coverage rate test data to be processed.

7. The method of claim 5, further comprising:
in case that neither the first code change record identifier nor the code change record identifier includes the latest code change record identifier and the first code change record is the same as the second code change record, merging the coverage rate test data to be processed and the historical coverage rate test data.

8. An electronic device comprising a processor and a memory;
the processor is provided for executing instructions stored in the memory to cause the device to perform a code coverage rate determining method comprising:
obtaining coverage rate test data to be processed and determining a code branch corresponding to the coverage rate test data to be processed, the coverage rate test data to be processed indicating a coverage rate of a software code corresponding to a first code change record identifier;
obtaining historical coverage rate test data corresponding to the code branch, the historical coverage rate test data indicating a coverage rate of a software code corresponding to a second code change record identifier; and
in case that the first code change record identifier or the second code change record identifier includes a latest code change record identifier corresponding to the code branch, determining a position of a first software code in a second software code and merging first coverage rate test data into second first coverage rate test data in accordance with the position of the first software code in the second software code, to obtain target coverage rate test data; wherein:
the first coverage rate test data is the coverage rate test data to be processed or the historical coverage rate test data, a code change record identifier corresponding to the first coverage rate test data does not include the latest code change record identifier, the second coverage rate test data is the coverage rate test data to be processed or the historical coverage rate test data, a code change record identifier corresponding to the second coverage rate test data includes the latest code change record identifier, the first software code is a software code corresponding to the first coverage rate test data, and the second software code is a software code corresponding to the second coverage rate test data.

9. The electronic device of claim 8, wherein determining a position of a first software code in a second software code includes:
determining a position of a target code in the first software code in the second software code, the target code being an executed code indicated by the first coverage rate test data.

10. The electronic device of claim 8, wherein a software code corresponding to the first code change record identifier corresponds to a first software version, a software code corresponding to the second code change record identifier corresponds to a second software version, and the first software version is different from the second software version.

11. The electronic device of claim 8, wherein the coverage rate test data to be processed include any one of:
full coverage rate test data, coverage rate test data produced during test, coverage rate test data corresponding to a test plan or coverage rate test data corresponding to a test use case.

12. The electronic device of claim 8, wherein the method further comprises:
determining the latest code change record identifier; and
judging whether the first code change record identifier and the code change record identifier include the latest code change record identifier.

13. The electronic device of claim 12, wherein the method further comprises:
in case that neither the first code change record identifier nor the code change record identifier includes the latest code change record identifier and the first code change record is different from the second code change record, discarding the coverage rate test data to be processed.

14. The electronic device of claim 12, wherein the method further comprises:
in case that neither the first code change record identifier nor the code change record identifier includes the latest code change record identifier and the first code change record is the same as the second code change record, merging the coverage rate test data to be processed and the historical coverage rate test data.

15. A non-transitory computer-readable storage medium comprising instructions that instruct a device to execute a code coverage rate determining method comprising:
obtaining coverage rate test data to be processed and determining a code branch corresponding to the coverage rate test data to be processed, the coverage rate test data to be processed indicating a coverage rate of a software code corresponding to a first code change record identifier;
obtaining historical coverage rate test data corresponding to the code branch, the historical coverage rate test data indicating a coverage rate of a software code corresponding to a second code change record identifier; and
in case that the first code change record identifier or the second code change record identifier includes a latest code change record identifier corresponding to the code branch, determining a position of a first software code in a second software code and merging first coverage rate test data into second first coverage rate test data in accordance with the position of the first software code in the second software code, to obtain target coverage rate test data; wherein:
the first coverage rate test data is the coverage rate test data to be processed or the historical coverage rate test data, a code change record identifier corresponding to the first coverage rate test data does not include the latest code change record identifier, the second coverage rate test data is the coverage rate test data to be processed or the historical coverage rate test data, a code change record identifier corresponding to the second coverage rate test data includes the latest code change record identifier, the first software code is a software code corresponding to the first coverage rate test data, and the second software code is a software code corresponding to the second coverage rate test data.

16. The non-transitory computer-readable storage medium of claim 15, wherein determining a position of a first software code in a second software code includes:
determining a position of a target code in the first software code in the second software code, the target code being an executed code indicated by the first coverage rate test data.

17. The non-transitory computer-readable storage medium of claim 15, wherein a software code corresponding to the first code change record identifier corresponds to a first software version, a software code corresponding to the second code change record identifier corresponds to a second software version, and the first software version is different from the second software version.

18. The non-transitory computer-readable storage medium of claim 15, wherein the coverage rate test data to be processed include any one of:
full coverage rate test data, coverage rate test data produced during test, coverage rate test data corresponding to a test plan or coverage rate test data corresponding to a test use case.

19. The non-transitory computer-readable storage medium of claim 15, wherein the method further comprises:
determining the latest code change record identifier; and
judging whether the first code change record identifier and the code change record identifier include the latest code change record identifier.

20. The non-transitory computer-readable storage medium of claim 19, wherein the method further comprises:
in case that neither the first code change record identifier nor the code change record identifier includes the latest code change record identifier and the first code change record is different from the second code change record, discarding the coverage rate test data to be processed.
